(19) United States
(12) Patent Application Publication
(10) Pub. No.: US 2025/0271605 A1
(43) Pub. Date: Aug. 28, 2025

(54) Light Control Film and Method of Fabricating Same

(71) Applicant: 3M INNOVATIVE PROPERTIES COMPANY, St. Paul, MN (US)

(72) Inventors: William T. Fay, Woodbury, MN (US); Timothy J. Lindquist, Woodbury, MN (US); Garth V. Antila, Hudson, WI (US); Stephen A. Johnson, Woodbury, MN (US); Li Yu, Santa Clara, CA (US); Tri D. Pham, Woodbury, MN (US)

(21) Appl. No.: 18/857,872

(22) PCT Filed: Apr. 24, 2023
(86) PCT No.: PCT/IB2023/054202

§ 371 Date: Oct. 18, 2024

Related U.S. Application Data
(60) Provisional application No. 63/339,005, filed on May 6, 2022.

(51) Int. Cl. G02B 5/22

(52) U.S. Cl. CPC G02B 5/223

(57) ABSTRACT

A light control film has opposing substantially planar substantially parallel first and second major surfaces spaced apart along a thickness direction of the light control film, and a plurality of substantially parallel optically transparent polymeric columns disposed in, and substantially surrounded by, a light absorbing polymeric material. Each of the polymeric columns has a first column end at the first major surface and an opposite second column end at the second major surface, such that the first column ends are arranged to define a plurality of substantially parallel alternating substantially linear rows of the first column ends and substantially linear rows of continuous light absorbing polymeric material. Methods of fabricating the light control film are described.

### SUMMARY

The present disclosure relates generally to light control films and methods of fabricating light control films. In some embodiments, a light control film includes a plurality of substantially parallel optically transparent polymeric columns disposed in, and substantially surrounded by, a light absorbing polymeric material. In some embodiments, a light control film is formed by forming an integral block from a stack of first films where each first film includes a plurality of alternating optically transparent and optically absorbing regions, and then cutting the light control film from the integral block.

In some aspects of the present description, a light control film is provided. The light control film has opposing substantially planar substantially parallel first and second major surfaces that can be spaced apart along a thickness direction of the light control film by less than about 500 microns, and a plurality of substantially parallel optically transparent polymeric columns disposed in, and substantially surrounded by, a light absorbing polymeric material. Each of the polymeric columns has a first column end at the first major surface and an opposite second column end at the second major surface and each of the polymeric columns can have an aspect ratio that can be greater than about 3, such that the first column ends are arranged to define a plurality of substantially parallel alternating substantially linear rows of the first column ends and substantially linear rows of continuous light absorbing polymeric material.

In some aspects of the present description, a light control film is provided. The light control film has opposing substantially planar substantially parallel first and second major surfaces that can be spaced apart along a thickness direction of the light control film by less than about 500 microns, and a plurality of substantially parallel optically transparent polymeric columns disposed in, and substantially surrounded by, a light absorbing polymeric material. Each of the polymeric columns has a first column end at the first major surface and an opposite second column end at the second major surface and each of the polymeric columns can have an aspect ratio of greater than about 3, such that the first column ends define a plurality of substantially parallelogram shapes arranged into a plurality of substantially parallel substantially linear rows.

In some aspects of the present description, a light control film including a plurality of optically transparent spaced apart polymeric columns substantially surrounded by a common light absorbing polymeric material is provided. The polymeric columns are arranged to define a plurality of substantially parallel alternating substantially planar rows of the columns and substantially planar rows of light absorbing polymeric material where the polymeric columns can have aspect ratios greater than about 3, such that for a substantially collimated incident light having a wavelength in a wavelength range from about 400 nm to about 2000 nm, an optical transmittance of the light control film versus an incident angle of the incident light in a first incident plane has a peak transmittance of greater than about 2% with a corresponding first full width at half maximum (FWHM) of between about 5 degrees and about 120 degrees.

In some aspects of the present description, a light control film is provided. The light control film has opposing substantially planar substantially parallel first and second major surfaces that can be spaced apart along a thickness direction of the light control film by less than about 500 microns, and a plurality of substantially parallel optically transparent polymeric columns disposed in, and substantially surrounded by, a light absorbing polymeric material, where each of the polymeric columns can have an aspect ratio that can be greater than about 3, such that in at least one cross-section orthogonal to the thickness direction and for each pair of a plurality of adjacent polymeric columns, the adjacent polymeric columns are nested and separated by the light absorbing polymeric material.

In some aspects of the present description, a light control film is provided. The light control film has opposing substantially planar substantially parallel first and second major surfaces that can be spaced apart along a thickness direction of the light control film by less than about 750 microns, and a plurality of substantially parallel optically transparent polymeric columns disposed in, and substantially surrounded by, a light absorbing polymeric material. Each of the polymeric columns has a first column end at the first major surface and an opposite second column end at the second major surface and each of the polymeric columns can have an aspect ratio of greater than about 3, such that the first column ends of at least one pair of adjacent first and second polymeric columns have respective first and second non-straight sides facing one another to define substantially complementary shapes.

In some aspects of the present description, a method of fabricating a light control film is provided. The method includes providing a plurality of first films where each first film has an orthogonal length and width and includes a plurality of alternating optically transparent polymeric first regions and light absorbing polymeric second regions where the first and second regions extend along the length and are arranged along the width and where each first region has a thickness along a thickness direction substantially orthogonal to the length and width; forming a stack of the first films along the thickness direction; applying at least one of pressure and heat to the stack of first films along at least one direction substantially orthogonal to the length. The at least one of pressure and heat can modify the thickness of the polymeric first regions.

In some aspects of the present description, a method of fabricating a light control film is provided. The method includes providing a plurality of first films where each first film has an orthogonal length and width and includes a plurality of alternating optically transparent polymeric first regions and light absorbing polymeric second regions where the first and second regions extend along the length and are arranged along the width and where each first region has a thickness along a thickness direction substantially orthogonal to the length and width; forming a stack of the first films along the thickness direction; and applying at least one of pressure and heat to the stack of first films along at least one direction substantially orthogonal to the length resulting in an integral block including optically transparent columns formed from the first regions.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a display system including a light control film disposed between a display panel and a sensor, according to some embodiments.

FIG. 2 is a schematic cross-sectional view of a display system including a light control film disposed between a display panel and a viewer, according to some embodiments.

FIG. 3 is a schematic cross-sectional view of a light absorbing material, according to some embodiments.

FIG. 4 is a schematic illustration of light incident on a portion of a light control film, according to some embodiments.

FIG. 5 is a schematic cross-sectional view of a light control film, according to some embodiments.

FIG. 6 is a schematic cross-sectional view of light incident on a light control film at an incident angle, according to some embodiments.

FIG. 7 is a plot of transmittance versus incident angle for various exemplary light control films.

FIGS. 8-13 are schematic cross-sectional views of light control films, according to some embodiments.

FIGS. 14-16 are schematic end views of portions of light control films, according to some embodiments.

FIGS. 17-20 are end views of portions of exemplary light control films.

FIG. 21 is a schematic illustration of a method of fabricating a light control film, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The light control films described herein may be used in finger sensing applications, according to some embodiments, where the light control film is disposed between a display panel and a sensor and can be adapted to transmit light reflected from a finger to the sensor while rejecting light incident on the light control film from different angles. By at least partially collimating the light in this way, the light control film can improve image resolution, for example. Unlike typical films including aligned microlens and pinhole arrays that are sometimes used as a collimation film in fingerprint detection systems, the light control films of the present description may, according to some embodiments, have a substantially flat major surface configured to face the display panel that can be readily bonded to the display panel, for example. Another type of collimation element that may be used in fingerprint sensing applications is a glass fiber optical plate. However, such plates suffer from a low manufacturing yield resulting in a high cost. According to some embodiments of the present description, the light control film includes substantially transparent (e.g., having an average optical transmittance in a wavelength range of 400 nm to 2000 nm or 420 nm to 680 nm of greater than 50%, or 60%, or 70%) polymeric columns disposed in, and substantially surrounded by (e.g., surrounded by greater than 75%, or 90%, or 95% of a circumference of the column in each cross-section orthogonal to a length of the column along greater than 75%, or 90%, or 95% of the length of the column), a light absorbing polymeric material. Such light control films can be made, according to some embodiments, by forming an integral block from a stack of first films where each first film includes a plurality of alternating optically transparent and optically absorbing regions, and then cutting the integral block to provide the light control film. Another application of the light control films described herein, according to some embodiments, is as privacy films adapted to reduce a viewing angle of light from a display panel, for example. The light control film can be used in an ultraviolet (e.g., ultraviolet sensors), visible (e.g., privacy filter), and/or infrared (e.g., fingerprint) wavelength range.

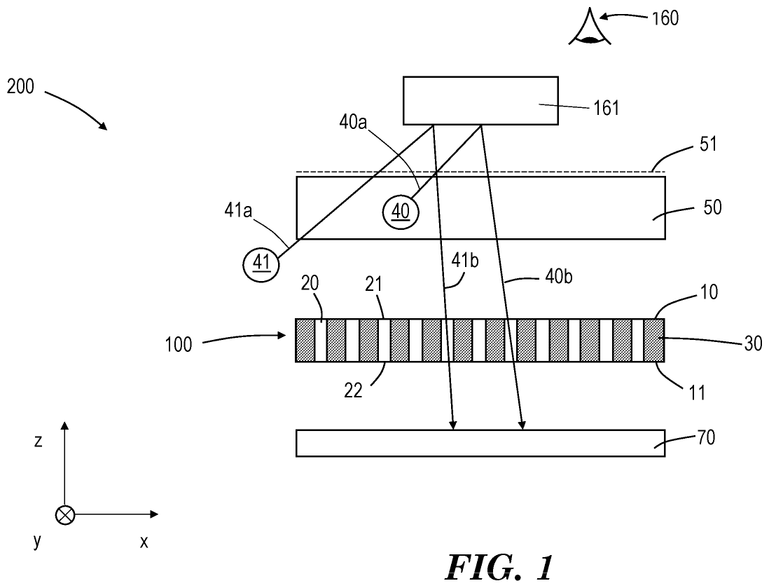

FIG. 1 is a schematic cross-sectional view of a display system 200, according to some embodiments. The display system 200 includes a light source 40, 41, and a light control film 100 disposed between an optical sensor 70 and a display panel 50 configured to generate an image 51 for viewing by a user 160. The light source 40, 41 is configured to emit a light 40a, 41a toward at least a finger 161 of the user 160 disposed proximate the display panel 50. The sensor 70 is configured to at least sense a presence of the finger 161 by receiving at least a portion 40b, 41b of the emitted light reflected by the finger 161. In some embodiments, the display system is configured to detect a fingerprint (e.g., for user authentication). In some embodiments, the display system 200 can detect a larger portion of the hand of the user 160 than a finger. For example, for sufficiently large display screens, the display system 200 may be configured to detect a palm print.

One of the light sources 40 and 41 may be omitted. In some embodiments, the display system 200 includes a light source 40 disposed inside the display panel 50. For example, the light source can be element(s) of an organic light emitting diode display (OLED). U.S. Pat. Appl. Pub. No. 2015/0331508 (Nho et al.), for example, describes OLED stacks incorporating near infrared (NIR) emitters for fingerprint detection. In some embodiments, the display system 200 includes a light source 41 disposed on a lateral side of the display system 200. For example, a near infrared light emitting diode can be disposed on a side of the display panel.

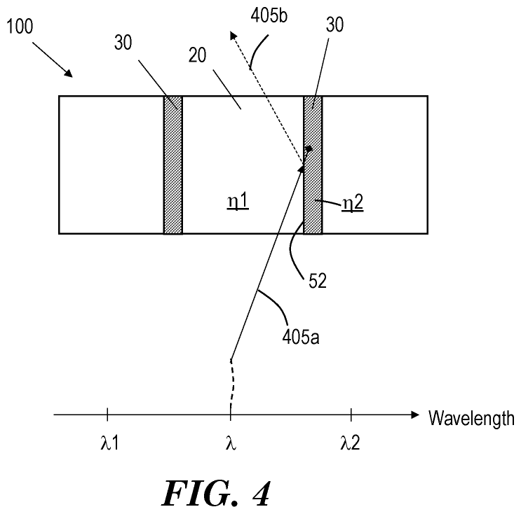

The emitted light 40a, 41a may have a wavelength in a range of λ1 to λ2 (see, e.g., FIG. 4), which may be a visible or visible/NIR range where λ1 can be about 400 nm or about 420 nm and λ2 can be about 800 nm or about 700 nm or about 680 nm, for example, or which may be a NIR range where λ1 can be about 800 nm or about 850 nm and λ2 can be about 2000 nm or about 1500 nm or about 1200 nm, for example. In some embodiments, the emitted light 40a, 41a has a wavelength between about 800 nm and about 2000 nm, or between about 800 nm and about 1500 nm, or between about 800 nm and about 1200 nm. In some embodiments, the emitted light 40a, 41a has a wavelength between about 400 nm and about 800 nm.

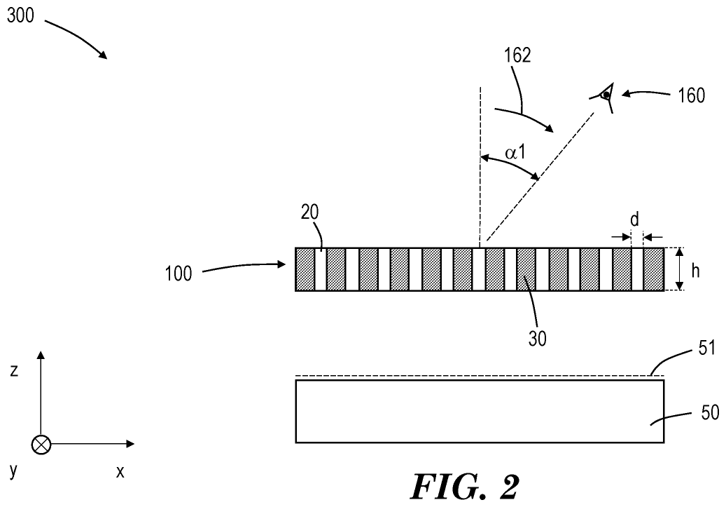

The light control films described herein may be used to reduce a viewing angle of a display. For example, the light control film may be used as a privacy filter. FIG. 2 is a schematic exploded cross-sectional view of a display system 300, according to some embodiments. The display system 300 includes a display panel 50 configured to generate an image 51 for viewing by a viewer 160, and a light control film 100 disposed on, and configured to be disposed between the viewer and, the display panel. The light control film reduces a viewing angle α1 of the generated image along at least one direction (e.g., direction 162).

The display panel 50 of FIG. 1 or 2 can be an organic light emitting diode (OLED) display panel, a liquid crystal display (LCD) panel, or a micro-light emitting diode (μLED) display panel, for example.

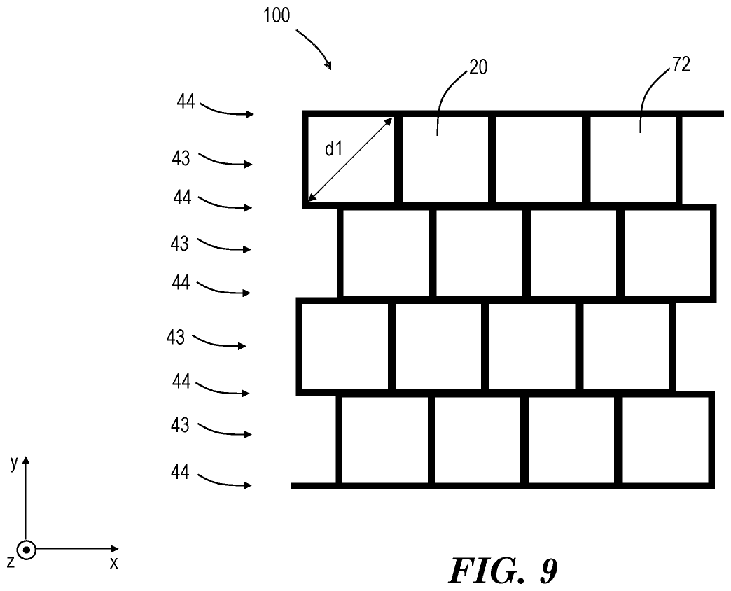

In some embodiments, a light control film 100 includes opposing substantially planar substantially parallel first and second major surfaces 10 and 11 spaced apart along a thickness direction (z-direction referring to the x-y-z coordinate system of FIGS. 1-2) of the light control film 100 by less than about 1 mm, for example; and a plurality of substantially parallel optically transparent polymeric columns 20 disposed in, and substantially surrounded by, a light absorbing polymeric material 30. A substantially planar surface of a light control film may have a deviation from a planar surface of less than about 3, 2, 1, 0.5, or 0.25 times a largest lateral dimension of a column 20, for example. The substantially planar surface may be nominally planar or planar up to deviations from planar small (e.g., less than about 20, 15, 10, or 5 percent) compared to a largest dimension of the surface, for example. The substantially parallel major surfaces may be within about 20, or 10, or 5 degrees of parallel, for example. The major surfaces 10 and 11 may be spaced apart by less than about 750, 700, 650, 600, 550, 500, 450, 400, or 300 microns, for example. The major surfaces 10 and 11 may be spaced apart by at least 100 microns, or at least 150 microns, or at least 200 microns, for example. Each of the polymeric columns 20 has a first column end 21 at the first major surface 10 and an opposite second column end 22 at the second major surface 11. Each of the polymeric columns having an aspect ratio (e.g., h/d indicated in FIG. 2) of greater than about: 3, or 4, or 5, or 6, or 7, or 8, or 9, or 10, or 11, or 12, or 13, or 14, or 15, or 17, or 20, or 25. The aspect ratio can be up to about 500 or up to about 200, for example. For example, in some embodiments, the polymeric columns have aspect ratios in a range of about 3 to about 500, or about 5 to about 200. The aspect ratio refers to the length (e.g., h) of the columns along a length direction of the columns divided by a lateral dimension of the columns in a direction orthogonal to the length direction, unless indicated otherwise. The lateral dimension may be the largest lateral dimension (e.g., d1 shown in FIG. 9). A high aspect ratio (e.g., greater than about 5) may be desired when a low viewing angle or a high degree of collimation is desired, while a lower aspect ratio (e.g., greater than about 3 and less than about 5) may be desired when a higher viewing angle, for example, is desired. The polymeric columns may have an in-plane aspect ratio less than 10 or less than 5, where the in-plane aspect ratio is the largest lateral dimension d1 divided by a minimum lateral dimension where the minimum lateral dimension is the smallest length between opposite sides of the column passing through a center (e.g., centroid) of the column in a lateral cross-section where a lateral cross-section is a cross-section orthogonal to the thickness direction (e.g., the largest lateral dimension can be a diagonal length and the minimum lateral dimension can be a width).

In some embodiments, at least one of the first and second column ends 21, 22 has an average longest lateral dimension d1 (see, e.g., FIG. 9) of between about 2 microns and about 100 microns, or about 3 microns and about 90 microns, or about 4 microns and about 80 microns, or about 5 microns and about 70 microns, or about 5 microns and about 60 microns, or about 5 microns and about 50 microns, or about 6 microns and about 40 microns, or about 6 microns and about 30 microns, or about 7 microns and about 30 microns. The average longest lateral dimension is the average (mean) of the longest lateral dimension (direction orthogonal to the length direction of the columns) of the column ends.

The columns 20 can be substantially coextensive in length with one another. Elements extending over a length may be described as substantially coextensive with each other, or as substantially coextensive in length with each other, if greater than 50% of each element is coextensive with greater than 50% by length of each other element. Elements extending over an area may be described as substantially coextensive with each other if greater than 50% by area of each element is coextensive with greater than 50 percent by area of each other element. Here, area refers to the area of a major surface of the layer or element. In some embodiments, for layers or elements described as substantially coextensive, at least about 70%, or at least about 80%, or at least about 90% by area of each layer or element is coextensive with at least about 70%, or at least about 80%, or at least about 90% by area of each other layer or element. In the case of a layer of a plurality of discrete elements, the area of the layer refers to the area within an outer boundary of a region defined by the plurality of discrete elements. In some embodiments, for at least a majority of the columns 20, greater than about 60%, or greater than about 80%, or greater than about 90%, or greater than about 95% of a length of each column is coextensive with greater than about 60%, or greater than about 80%, or greater than about 90%, or greater than about 95% of a length of each other column. Layers or elements can be described as substantially coextensive with each other in length and width if at greater than 50% of the length and width of each layer or element is co-extensive with greater than 50% of the length and width of each other layer or element. In some embodiments, for layers or elements described as substantially coextensive with each other in length and width, at least about 70%, or at least about 80%, or at least about 90% of each layer or element is co-extensive in length and width with at least about 70%, or at least about 80%, or at least about 90% of the length and width of each other layer or element.

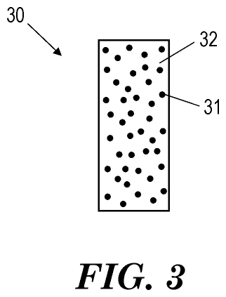

FIG. 3 is a schematic cross-sectional view of light absorbing polymeric material 30, according to some embodiments. A polymeric material is a material including a continuous phase of organic polymer, unless indicated differently. A polymeric material may include inorganic material in a polymer matrix, for example. In some embodiments, the light absorbing polymeric material 30 includes a plurality of light absorbing particles 31 dispersed in an optically transparent binder 32. In this context, a particle 31 may be a dye molecule, for example, or a pigment particle, for example. The light absorbing particles 31 may also partially reflect and/or diffuse light in addition to absorbing light (e.g., at least one wavelength in a visible range of 400 nm to 700 nm). In some embodiments, the light absorbing particles includes dark pigments or dark dyes such as black or gray pigments or dyes; metal such as aluminum, silver, etc.; dark metal oxides; or a combination thereof. Suitable light absorbing particles 31 include carbon black. Other suitable dyes and pigments may include, for example, one or more of Disperse Blue 60 (C₂₀H₁₇N₃O₅; CAS Number 12217-80-0); Pigment Yellow 147 (C₃₇H₂₁N₅O₄; CAS Number 4118-16-5); red azo dyes such as Red Dye 40 (C₁₈H₁₄N₂Na₂O₈S₂; CAS Number 25956-17-6); anthraquinone dyes or pigments such as Solvent Yellow 163 (C₂₆H₁₆O₂S₂; CAS Number 13676-91-0), Pigment Red 177 (C₂₈H₁₆N₂O₄; CAS Number 4059-63-2), and Disperse Red 60 (C₂₀H₁₃NO₄; CAS Number 12223-37-9); perylene dyes or pigments such as Pigment Black 31 (C₄₀H₂₆N₂O₄; CAS Number 67075-37-0), Pigment Black 32 (C₄₀H₂₆N₂O₆; CAS Number 83524-75-8), and Pigment Red 149 (C₄₀H₂₆N₂O₄; CAS Number 4948-15-6); and the blue, yellow, red and cyan dyes PD-325H, PD-335H, PD-104 and PD-318H, respectively, available from Mitsui Fine Chemicals, Tokyo Japan. In some cases, a mixture of such dyes or pigments may be used to achieve optical absorption throughout a desired wavelength range (e.g., a wavelength range of about 400 nm to about 2000 nm or a visible wavelength range extending at least from 420 nm to 680 nm). In some embodiments, the light absorbing particles 31 include one or more of a light absorbing pigment, a light absorbing dye, and a carbon black.

In some embodiments, at least one of the plurality of polymeric columns 20 and the light absorbing polymeric material 30 (e.g., the binder 32 of the material 30) includes one or more of a polycarbonate, a polyester, an acrylic, a polyethylene terephthalate (PET), a glycol-modified PET (PETg) which can be described as PET with some of the glycol units of the polymer replaced with different monomer units, typically those derived from cyclohexanedimethanol, a polymethylmethacrylate (PMMA), a polyethylene naphthalate (PEN), a polybutylene terephthalate (PBT), polytrimethyleneterephthalate (PTT), a polyphenylene sulphone (PPSU), a polyether sulphone (PES), a polyphenylene sulfide (PPS), a polyetherimide (PEI), a sulfonated polysulfone (SPSU), polypropylene, a polyethylene (PE), a low density polyethylene (LDPE), an expanded polypropylene (EPP), a polylactide (PLA), a cyclic olefin, a polyurethane, a cellulose acetate (CA), a cellulose acetate butyrate (CAB), a cellulose acetate propionate (CAP), a styrene-butadiene-styrene (SBS), a styrene-ethylene-butadiene-styrene (SEBS), a nylon (also known as a polyamide (PA)), a polyurea, a rayon, a polyvinyl chloride (PVC), a polyvinylidene chloride (PVDC), a polybutylene (PB), a polymethyl pentane (e.g., TPX), a polytene, a polynorbornene, a polyvinyl alcohol (PVOH), a polyvinyl acetate (PVA), a polyaramid, a meta-aramid, a polybenzoxazole (PBO), a polybenzimidazole (PBI), a polyhydroquinone-diimidazopyridine (PIPD), a thermotropic liquid crystalline polymer (TLCP), and any copolymers thereof. LDPE is a grade of polyethylene characterized by a density in a range of about 910 to 940 kg/m³ or about 917 to 930 kg/m³.

FIG. 4 is a schematic illustration of light 405a incident on a portion of a light control film 100, according to some embodiments. The light 405a has a wavelength λ in a range of λ1 to λ2, which may be a range of about 400 nm to about 2000 nm, or about 700 nm to about 2000 nm, or about 400 nm to about 700 nm, or about 420 nm to about 680 nm, or about 450 nm to about 650 nm, for example. The polymeric columns 20 have an index of refraction n1 for the wavelength λ and the light absorbing material 30, or a binder component of the light absorbing material 30, has an index of refraction n2 for the wavelength λ. The index of refraction n1, n2 refers to the real part of the index, unless indicated differently. The polymeric columns 20 and the light absorbing material 30 may be selected to reduce or eliminate total internal reflection so that the light 405a is substantially absorbed by the light absorbing material 30 instead of being reflected at an interface 52 between polymeric columns 20 and the light absorbing material 30 as reflected light 405b. For example, an index of refraction of the polymeric columns may be less than or approximately equal to an index of refraction of the binder. In some embodiments, for at least one wavelength (e.g., λ) in a visible wavelength range extending from about 420 nm to about 680 nm (or from λ1 to λ2), an index of refraction of the polymeric columns is less than an index of refraction of the binder. In some embodiments, for at least one wavelength in a visible wavelength range extending from about 420 nm to about 680 nm (or from λ1 to λ2), an index of refraction of the polymeric columns is greater than an index of refraction of the binder. In some embodiments, for at least one wavelength in a visible wavelength range extending from about 420 nm to about 680 nm, a magnitude of a difference between an index of refraction of the polymeric columns and an index of refraction of the binder is less than about 0.01, or 0.005, or 0.001. In some embodiments, interfaces 52 between the light absorbing polymeric material 30 and the polymeric columns 20 do not cause total internal reflection. In some embodiments, the light absorbing polymeric material 30 includes a plurality of layers (e.g., a layer of higher optical absorption material disposed between layers of lower optical absorption material) as described further elsewhere herein.

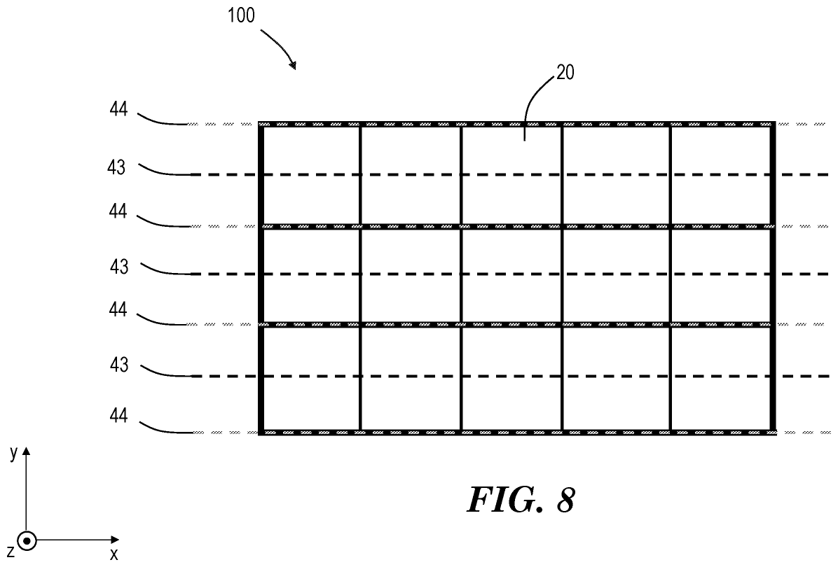

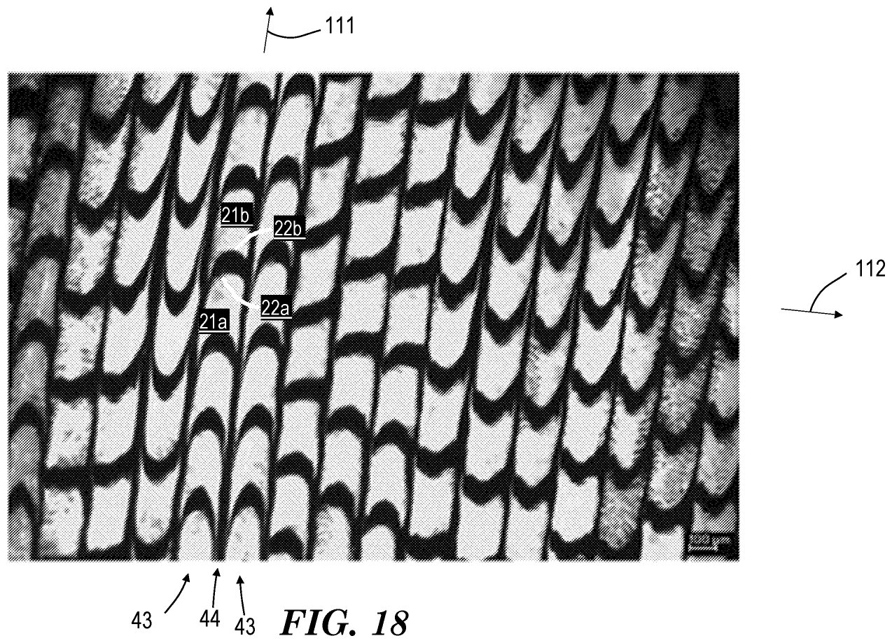

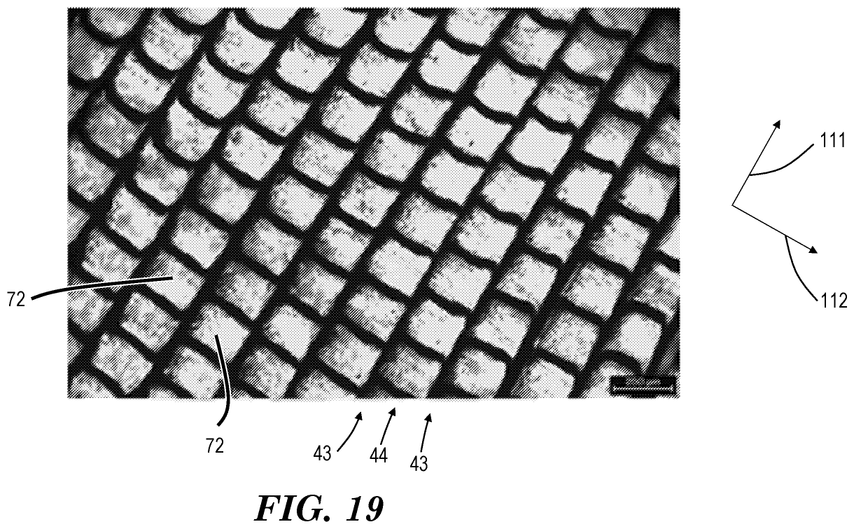

The column ends 21 (resp., 22) may cover a substantially larger fraction (by area) of the major surface 10 (resp., 11) than schematically illustrated in FIGS. 1 and 2, for example. Larger area fractions are schematically illustrated in FIG. 4, for example (see also FIGS. 8-13 and 17-20, for example). In some embodiments, the first column ends 21 cover at least 40%, or 45%, or 50%, or 60%, or 65%, or 70%, or 75%, or 80%, or 85% of the first major surface 10. The first column ends 21 may cover up to 98%, or up to 95%, or up to 92%, or up to 90% of the first major surface 10, for example. In some embodiments, the second column ends 22 cover at least 40%, or 45%, or 50%, or 60%, or 65%, or 70%, or 75%, or 80%, or 85% of the second major surface 11. The second column ends 22 may cover up to 98%, or up to 95%, or up to 92%, or up to 90% of the second major surface 11, for example.

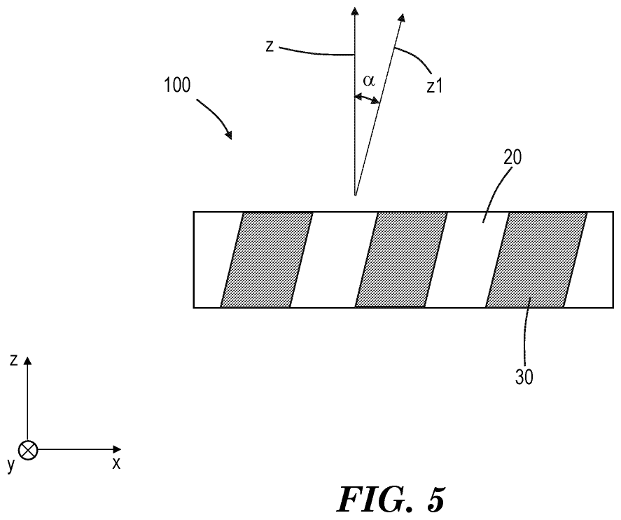

In some embodiments of the light control film 100, the polymeric columns 20 are tilted relative to the thickness direction of the light control film 100. The tilt can be provided by forming an integral block as described further elsewhere herein and cutting the block at an angle relative to a length direction of the block to provide the light control film. FIG. 5 is a schematic cross-sectional view of a light control film 100, according to some embodiments. In some embodiments, in at least one cross-section of the light control film 100 in a plane (e.g., xz-plane) comprising the thickness direction (z-direction), the polymeric columns generally extend along a first direction (z1) making an angle α of between about 2 degrees and about 60 degrees, or about 2 degrees and 50 degrees, or about 3 degrees and 50 degrees, or about 4 degrees and 40 degrees, or about 5 degrees and 40 degrees with the thickness direction. In other embodiments, the angle α may be about 0 degrees. In some embodiments, in at least one cross-section of the light control film 100 in a plane comprising the thickness direction (z-direction), the polymeric columns generally extend along a direction substantially parallel (e.g., within about 20, 10, 5, 3, 2, or 1 degrees of parallel) to the thickness direction (z-direction).

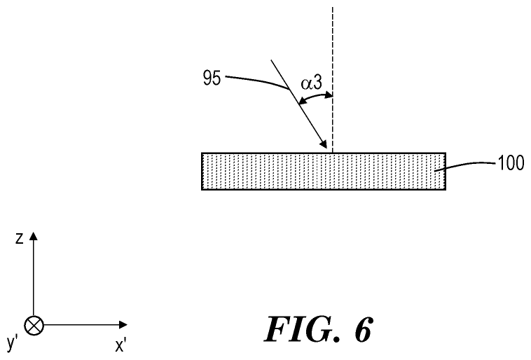

FIG. 6 is a schematic cross-sectional view of a substantially collimated incident light 95 incident on a light control film 100 at an incident angle α3 (angle with normal to the major surface on which the light is incident), according to some embodiments. The x′ and y′ coordinates in FIG. 6 may correspond to the x and y coordinates so that the illustrated x′-z plane is the x-z plane. Or the x′ and y′ axes may be rotated about the z-axis (e.g., by about 90 degrees) relative to the x and y axes (e.g., so that the illustrated x′-z plane is the y-z plane).

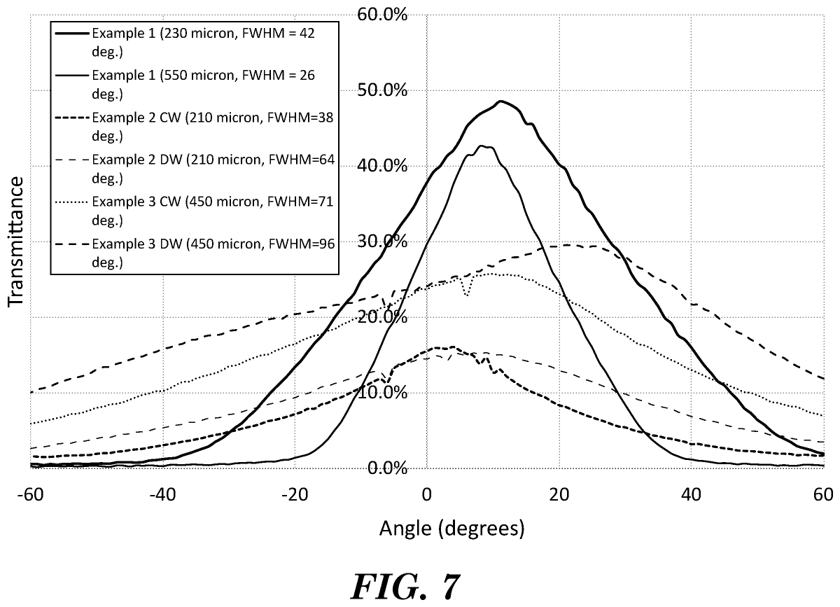

FIG. 7 is a plot of transmittance versus incident angle for various exemplary light control films. The substantially collimated light 95 can have a divergence or convergence angle that is less than about 20, 10, 5 or 3 degrees, and/or that is small compared to a full width at half maximum (e.g., less than 20% or 10% or 5% of the full width at half maximum) of a transmittance through the light control film versus incident angle. In some embodiments, an optical transmittance of the light control film versus an incident angle «3 of the incident light in a first incident plane (e.g., x-z plane) has a peak transmittance of greater than about 2% with a corresponding first full width at half maximum (FWHM) of between about 5 degrees and about 120 degrees. In some such embodiments, or in other embodiments, the peak transmittance is greater than about: 5%, or 10%, or 15%, or 20%, or 25%, or 30%, or 35%, or 40%. The peak transmittance may be up to about 80%, or up to about 70%, or up to about 60% for example. In some such embodiments, or in other embodiments, the corresponding FWHM is between about 10 degrees and about 100 degrees, or between about 10 degrees and about 80 degrees, or between about 10 degrees and about 70 degrees, or between about 10 degrees and about 60 degrees, or between about 10 degrees and about 50 degrees, or between about 15 degrees and about 45 degrees, for example. The desired range of the FWHM may be such that a sufficient quantity of light is transmitted through the light control film (e.g., the FWHM can be at least about 10 degrees, or at least about 15 degrees, or at least about 20 degrees, for example) and such that incident angles greater than a predetermined amount are substantially not transmitted (e.g., the FWHM can be no more than about 120 degrees, or no more than about 80 degrees, or no more than about 50 degrees, for example). In some embodiments, the peak transmittance corresponds to an incident angle of less than about 5 degrees, or less than about 3 degrees, or less than about 2 degrees. In some embodiments, the peak transmittance corresponds to an incident angle of greater than about 5 degrees, or greater than about 10 degrees, or greater than about 15 degrees. The peak transmittance may correspond to an incident angle of up to about 50 degrees, or up to about 45 degrees, or up to about 40 degrees, or up to about 35 degrees, for example. In some embodiments, the optical transmittance versus incident angles is averaged over azimuthal angles.

In some embodiments, the optical transmittance of the light control film 100 versus incident angle has a FWHM in any of these ranges for each of two orthogonal incident planes. An incident plane is a plane comprising the thickness direction (z-direction) and the direction of the incident light (e.g., 95). The two orthogonal incident planes can be the xz-plane and the yz-plane, for example. In some embodiments, the optical transmittance of the light control film 100 versus incident angle in a second incident plane (e.g., yz-plane) different from the first incident plane has a transmitted peak with a corresponding second FWHM different from the first FWHM by at least about 10%, or 20%, or 30%, or 40%, or 50%, for example. The FWHMs can differ by up to about 95%, 90%, 80%, or 75%, for example. In some embodiments, the first and second FHWMs differ by at least about 5, 10, 15, 20, or 25 degrees. The FWHMs can differ by up to about 50, 45, 40, 35, or 30 degrees, for example. In some embodiments, the FWHMs differ by less than about 10 or 5 degrees, or by less than about 10 or 5 percent, for example. For some examples, data is shown in FIG. 7 for the incident plane comprising a cross-web (CW) direction and for the incident plane comprising an orthogonal down-web (DW) direction.

In some embodiments, a light control film 100 includes a plurality of optically transparent spaced apart polymeric columns 20 substantially surrounded by a common light absorbing polymeric material 30, where the polymeric column are arranged to define a plurality of substantially parallel alternating substantially planar rows 43 (see, e.g., FIGS. 8-20) of the columns and substantially planar rows 44 (see, e.g., FIGS. 8-20) of light absorbing polymeric material, such that for a substantially collimated incident light 95 having a (or at least one) wavelength (e.g., λ) in a wavelength range from about 400 nm to about 2000 nm (or from λ1 to λ2), an optical transmittance of the light control film versus an incident angle α3 of the incident light in a first incident plane (e.g., x-z plane) has a peak transmittance of greater than about 2% (or in another range described elsewhere herein) with a corresponding first full width at half maximum (FWHM) of between about 5 degrees and about 120 degrees (or in another range described elsewhere herein). The wavelength in the wavelength range from about 400 nm to about 2000 nm can be a visible wavelength in a visible wavelength range from about 400 nm to about 700 nm, or about 420 nm to about 680 nm, or about 450 nm to about 650 nm, for example. The visible wavelength can be about 530 nm, for example. In some embodiments, an optical transmittance of the light control film versus an incident angle α3 of the incident light in a second incident plane (e.g., y-z plane) different from the first incident plane has a transmitted peak with a corresponding second FWHM different from the first FWHM by at least about 10% or in another range described elsewhere herein). In some embodiments, the second incident plane is substantially orthogonal (e.g., within about 30, 20, 10, or 5 degrees of orthogonal) to the first incident plane. In some embodiments, each of the second FWHM is between about 5 degrees and about 160, 140, or 120 degrees, or the second FWHM can be in another range described elsewhere herein for the first FWHM. In some embodiments, an optical transmittance of the light control film versus an incident angle α3 of the incident light in a second incident plane (e.g., y-z plane) substantially orthogonal to the first incident plane has a transmitted peak with a corresponding second FWHM about the same (e.g., within 5, 4, 3, or 2 percent) as the first FWHM.

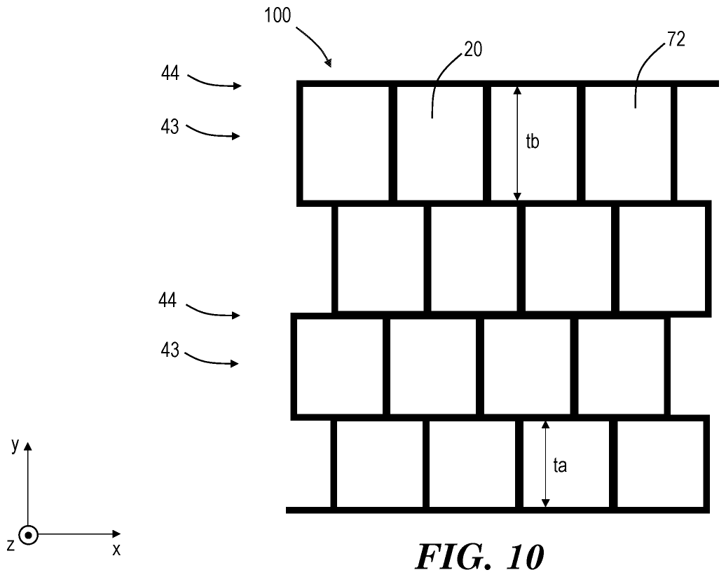

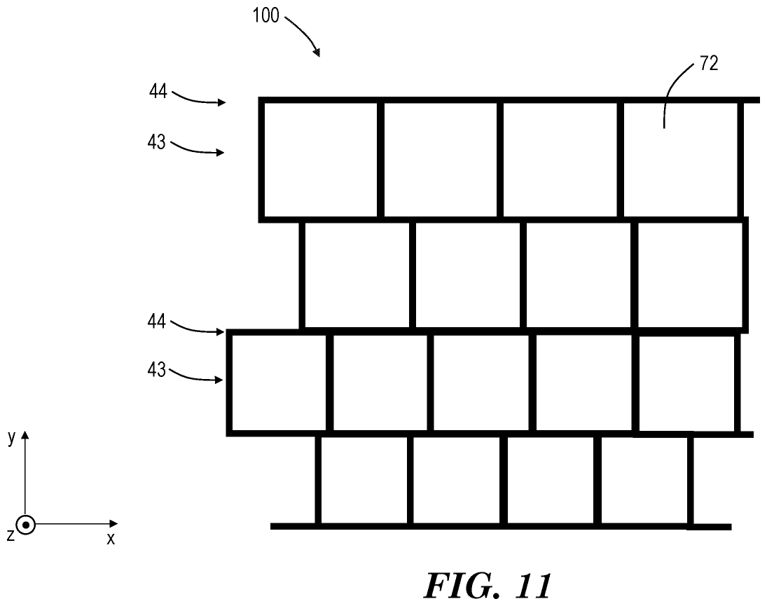

FIGS. 8-13 are schematic cross-sectional views of light control films, according to some embodiments. The cross-sections are orthogonal to the thickness direction (z-direction) and may be coincident with one of the first and second major surfaces 10 and 11 so that the illustrated columns 20 may be coincident with ends of the columns. The columns 20 can be arranged into rows 43 of the columns separated by rows 44 of light absorbing material. Adjacent rows 43 can be aligned as schematically illustrated in FIG. 8 or adjacent rows 43 can be displaced along a first direction (x-direction) as schematically illustrated in FIGS. 9-11, for example. The displacements in the first direction can be regular as schematically illustrated in FIGS. 9-10, for example, or irregular as schematically illustrated in FIG. 11, for example. Irregular displacements may be desired to reduce moiré, for example.

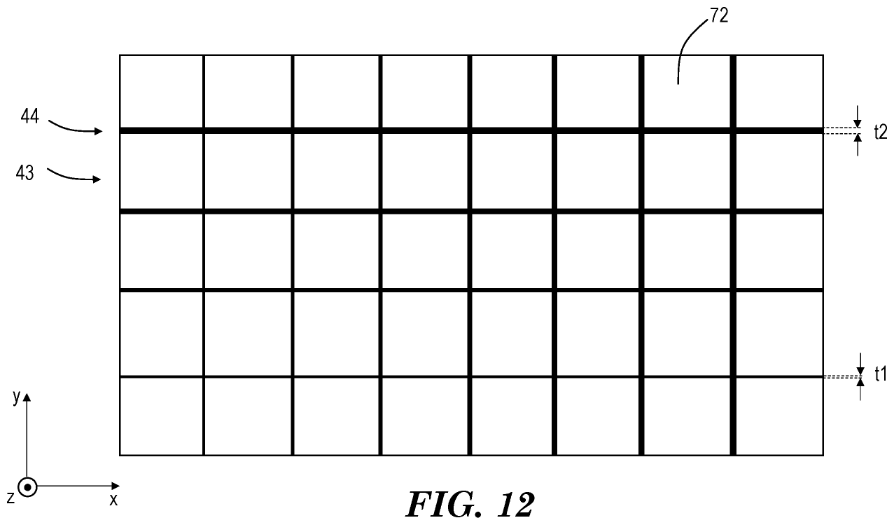

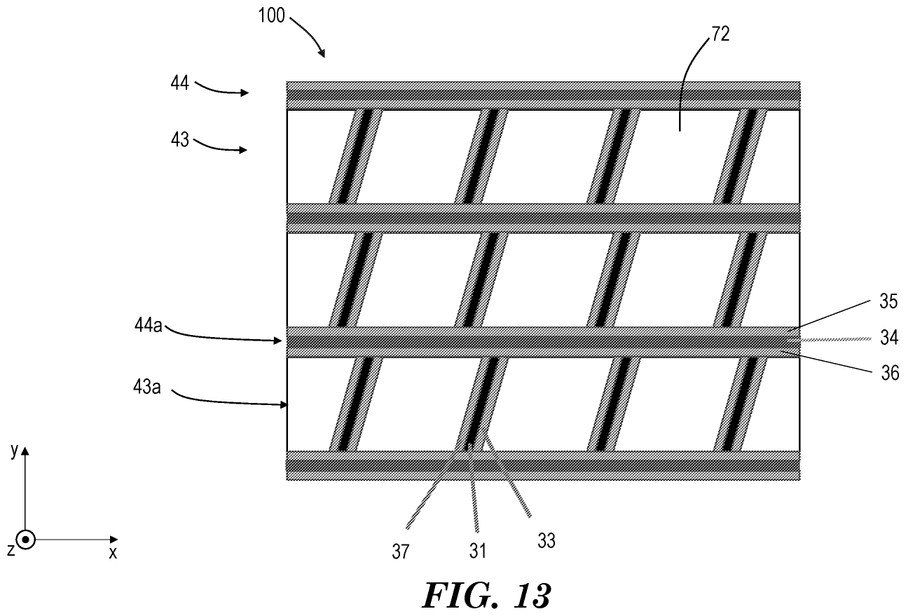

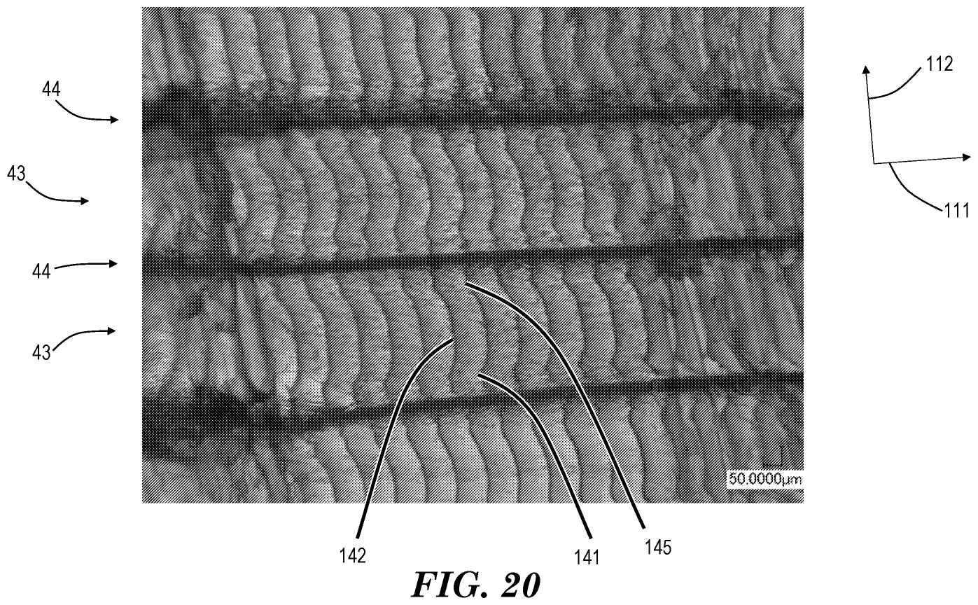

In some embodiments, as schematically illustrated in FIGS. 10-11, for example, the sizes of the column cross-sections or ends can vary in the first direction (x-direction), a second direction (y-direction) orthogonal the first direction and to the thickness direction), or both. In some such embodiments, or in other embodiments, the thickness of the light absorbing material between the columns can vary in the first direction, second direction, or both (see, e.g., FIG. 12). In some embodiments, the light absorbing material between the columns of at least some of the rows, or the light absorbing materials between at least some of the adjacent rows, or both, can include more than one layer (see, e.g., FIG. 13). For example, less optically absorptive outer layers and a more optically absorptive inner layer may be used to reduce unwanted reflection from interfaces between the columns and the light absorbing materials that might otherwise result in ghosting (see, e.g., U.S. Pat. No. 5,254,388). In some embodiments, the light absorbing material between the columns of the rows and the light absorbing materials between the rows can have different optical absorption (see, e.g., FIG. 13) and/or different thicknesses (see, e.g., FIGS. 13 and 20) which can result in different shapes for the optical transmittance of the light control film vs. incident angle of incident light in different incident planes (e.g., so the transmission can have a wider FWHM in a horizontal direction for viewers off axis and a narrower FWHM in a vertical direction). In some embodiments, the column cross-sections or ends have a substantially parallelogram shape 72. Rectangles and squares are special cases of parallelograms, so FIGS. 8-13, for example, schematically illustrate parallelogram shapes. Using rectangles such that the pitch of the columns in the x- and y-directions are different can result in different shapes for the optical transmittance of the light control film vs. incident angle of incident light in orthogonal incident planes. FIG. 13 schematically illustrates a substantially parallelogram shape 72 where adjacent sides of the parallelogram shape do not form right angles. In some embodiments, at least some (e.g., at least about 50, 60, 70, 80, or 90 percent) of the substantially parallelogram shapes have no right angles (e.g., each angle of the substantially parallelogram shape can deviate from a right angle by at least about 10, 20, or 30 degrees and up to about 70, 60, or 50 degrees, for example). Using parallelograms with no right angles can result in different shapes for the optical transmittance of the light control film vs. incident angle of incident light in different non-orthogonal incident planes.

As described further elsewhere herein, the light control film can be made by extruding a plurality of louver films, stacking the louver films, fusing the stacked louver films, and cutting the light control film from the fused stack. Variation in the columns, or in light absorbing materials between the columns, along the rows 43 in the first direction can be achieved and controlled by the choice of the die (e.g., suitably choosing the geometry of exit orifices of the die) used to extrude the louver film corresponding to the row. Variations in the second direction can be achieved and controlled by suitably choosing the louver films, and/or optional optically absorptive layers disposed between the louver films, in forming the stack of louver films.

In some embodiments, a light control film 100 includes a plurality of substantially parallel (e.g., within about 25, 20, 15, 10, or 5 degrees of parallel) optically transparent polymeric columns 20 disposed in, and substantially surrounded by, a light absorbing polymeric material 30, where each of the polymeric columns has a first column end 21 at the first major surface 10 and an opposite second column end 22 at the second major surface 11, such that the first column ends are arranged to define a plurality of substantially parallel alternating substantially linear rows 43 of the first column ends and substantially linear rows 44 of continuous light absorbing polymeric material. In some embodiments, the rows of continuous light absorbing polymeric material are thinner than the rows of first column ends. The rows of continuous light absorbing polymeric material can be thinner than the rows of first column ends by at least a factor of about 2, 3, 4, or 5, for example. The factor may be up to about 1000, 500, 250, 100, or 50, for example. Substantially linear or planar or straight rows or sides can be understood to be nominally linear or planar or straight, or linear or planar or straight up to deviations small (e.g., less than about 20, 10, or 5 percent) compared to the overall length of the row or side, for example.

In some embodiments, the first column ends of each row of first column ends are separated by light absorbing polymeric material. In some embodiments, the light absorbing polymeric material between the first column ends in each row of first column ends has a first composition, and the light absorbing polymeric material of the rows of continuous light absorbing polymeric material has a second composition different than the first composition. For example, the different compositions can have a different concentration of light absorbing material. In some embodiments, the light absorbing polymeric material between the first column ends in each row of first column ends has a first optical density, and the light absorbing polymeric material of the rows of continuous light absorbing polymeric material has a second optical density different than the first optical density. In some embodiments, the light absorbing polymeric material between the first column ends in each row of first column ends is more optically absorptive than the light absorbing polymeric material of the rows of continuous light absorbing polymeric material. In some embodiments, the light absorbing polymeric material between the first column ends in each row of first column ends is less optically absorptive than the light absorbing polymeric material of the rows of continuous light absorbing polymeric material. The optical density can be expressed as minus the base 10 logarithm of [transmittance/100%], where the transmittance (in %) is for unpolarized normally incident light, unless indicated differently. The incident light can be incident across the narrowest dimension (width) of the light absorbing material and may have a uniform distribution of wavelengths from about 420 nm to about 680 nm.

In some embodiments, for at least one row 43a (see, e.g., FIG. 13) of the first column ends, at least one pair of adjacent first column ends are separated by at least first and second light absorbing layers 31 and 37 substantially coextensive with the adjacent first column ends. The first light absorbing layer 31 can be more optically absorptive than the second light absorbing layer 37. In some embodiments, the at least one pair of adjacent first column ends are further separated by a third light absorbing layer 33 substantially coextensive with the first and second light absorbing layers. The first light absorbing layer 31 can be disposed between the second and third light absorbing layers 37 and 33. The first light absorbing layer 31 can be more optically absorptive than the third light absorbing layer 33. The at least one row 43a can include at least 50, 60, 70, 80, 90, or 95 percent of all of the rows 43 of the first column ends. For each of the at least one row, the at least one pair of adjacent first column ends can include at least 50, 60, 70, 80, 90, or 95 percent of all pairs of adjacent first column ends. In some embodiments, at least one row 44a of continuous light absorbing polymeric material includes first and second light absorbing layers 34 and 35 extending continuously along the at least one row. The first light absorbing layer 34 can be more optically absorptive than the second light absorbing layer 35. In some embodiments, the at least one row of continuous light absorbing polymeric material includes a third light absorbing layer 36 extending continuously along the at least one row. The first light absorbing layer 34 can be disposed between the second and third light absorbing layers 35 and 36. The first light absorbing layer 34 can be more optically absorptive than the third light absorbing layer 36. The at least one row 44a can include at least 50, 60, 70, 80, 90, or 95 percent of all of the rows 44 of continuous light absorbing polymeric material.

In some embodiments, each of a plurality of the first column ends has a substantially parallelogram shape. Substantially parallelogram shape can be understood to mean nominally parallelogram shape, or parallelogram shaped up to deviations small (e.g., less than about 20, 15, or 10 percent) compared to a largest dimension of the shape, or parallelogram shaped up to corners and sides have radii of curvature lager (e.g., greater than about 5, 10, or 20 times) than other dimensions (e.g., the largest dimension) of the shape and/or angles between opposite sides being substantially parallel (e.g., within 20, 10, or 5 degrees of parallel). Substantially rectangular and substantially square, for example, can be understood similarly. In some embodiments, each of a plurality of the first column ends has a substantially rectangular shape. In some embodiments, each of the rows of first column ends has a substantially same thickness (e.g., the same to within about 5, 2, or 2 percent). In some embodiments, at least two different rows of first column ends have different thicknesses (e.g., ta and tb schematically illustrated in FIG. 10). The thicknesses of the at least two different rows of first column ends can differ by at least about 10, 20, or 30 percent, for example. The thicknesses of the at least two different rows of first column ends can differ by up to about 200, 100, or 50 percent, for example. In some embodiments, each of the rows of continuous light absorbing material has a substantially same thickness. In some embodiments, at least two different rows of continuous light absorbing material have different thicknesses (e.g., t1 and t2 schematically illustrated in FIG. 12). The thicknesses of the at least two different rows of continuous light absorbing material can differ by at least about 10, 20, or 30 percent, for example. The thicknesses of the at least two different rows of continuous light absorbing material can differ by up to about 1000, 500, 200, or 100 percent, for example.

In some embodiments, the first column ends are regularly arranged in a two-dimensional array. In some embodiments, the plurality of first column ends is more periodic along a first direction and less periodic along a second direction substantially orthogonal to the first direction. For example, in some embodiments, the rows can be defined by a plurality of louver films having the columns periodically arranged along the first direction where the louver films are stacked along the second direction with irregular displacements in the first direction relative to one another. In some embodiments, the polymeric columns 20 are arranged to define a plurality of substantially parallel alternating substantially planar rows 43 of the columns and substantially planar rows 44 of continuous light absorbing polymeric material. In some embodiments, for each row of at least a majority (e.g., greater than 50, 60, 70, 80, or 90 percent) of the rows of the columns, the columns are regularly arranged in the row along a first direction (x-direction). In some embodiments, the rows of columns are stacked in a second direction (y-direction) orthogonal to the first and thickness directions with a displacement of the rows in the first direction varying irregularly in the thickness direction.

In some embodiments, the difference in periodicity of the plurality of column ends along different directions is characterized by relative amplitudes of peaks of a Fourier transform of the column ends. In some embodiments, a two-dimensional Fourier transform of the first column ends has a first peak for a non-zero spatial frequency along a first direction (e.g., a ky-direction), and any second peak of the Fourier transform at a non-zero spatial frequency along a second direction (e.g., a kx-direction) substantially orthogonal to the first direction is smaller than the first peak by at least about 10, 20, or 30%. For example, the randomness of the displacement of the rows in the x-direction can suppress peaks in the two-dimensional Fourier transform for spatial frequencies along a kx direction corresponding to the x-direction.

The geometry, composition, absorption, etc. described for the first column ends 21 and adjacent light absorbing polymeric materials at the first major surface 10 can also apply to the second column ends 22 and adjacent light absorbing polymeric materials at the second major surface 11 and/or can also apply to columns 20 and surrounding light absorbing polymeric material 30.

In some embodiments, a light control film includes a plurality of substantially parallel optically transparent polymeric columns 20 disposed in, and substantially surrounded by, a light absorbing polymeric material 30, where each of the polymeric columns has a first column end 21 at the first major surface and an opposite second column end 22 at the second major surface, such that the first column ends define a plurality of substantially parallelogram shapes 72 arranged into a plurality of substantially parallel substantially linear rows. In some embodiments, the plurality of substantially parallelogram shapes includes a plurality of substantially rectangular shapes (e.g., squares or rectangles having a length greater than a width). In some embodiments, the plurality of substantially parallelogram shapes includes a plurality of substantially square shapes. In some embodiments, the first column ends are arranged to define a plurality of substantially parallel alternating substantially linear rows 43 of the first column ends and substantially linear rows 44 of continuous light absorbing polymeric material. In some embodiments, the polymeric columns 20 are arranged into a plurality of substantially parallel planes. In some embodiments, the plurality of polymeric columns 20 is substantially surrounded by the material 30 when at least about 60, 70, 80, 90, or 95 percent of a perimeter of the plurality of columns 20 in each cross-section along the length of the plurality of columns 20 is surrounded by the material 30. In some embodiments, each of at least about 60, 70, 80, 90, or 95 percent of each of the polymeric columns is substantially surrounded by the material 30.

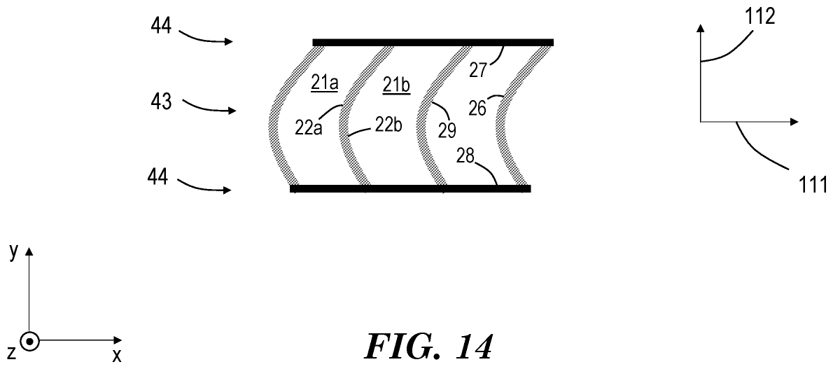

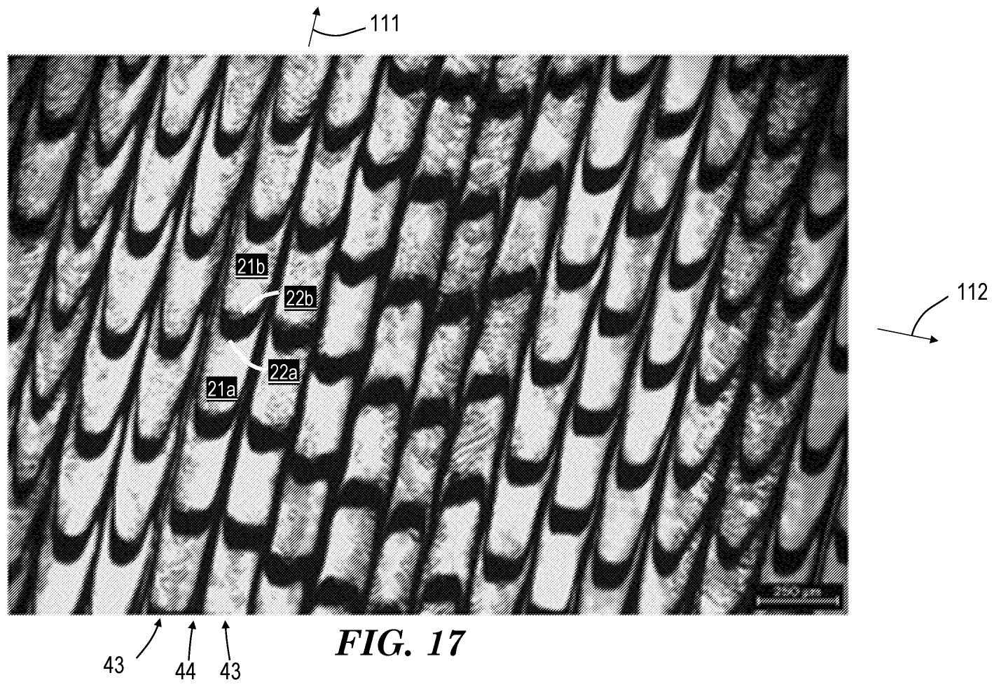

FIGS. 14-16 are schematic end views of portions of light control films, according to some embodiments. The columns of the light control film may have a cross-section substantially uniform in the thickness direction so that FIGS. 14-16 may also correspond to cross-sectional views of the illustrated portions of the light control films. FIGS. 17-20 are end views of portions of light control films, according to some embodiments.

In some embodiments, for at least one row 43 of the first column ends, the first column ends and light absorbing polymeric material define at least one pair of adjacent interfaces 22a, 22b concave toward a same direction 111. Curves or interfaces concave toward a direction means that the surface or interface curve toward the direction with ends of the curve or interface further displaced along the direction than portions of the surface or interface between the ends. The adjacent interfaces 22a, 22b can be substantially parallel. An object with a concave surface means that the surface curves inward while an object with a convex surface means that the surface curves outward.

In some embodiments, for at least one row of the first column ends, opposite sides 27, 28 of the first column ends forming interfaces with adjacent rows of continuous light absorbing polymeric material are substantially straight and substantially parallel. In some embodiments, for each pair of a plurality of adjacent first column ends, the adjacent first column ends are nested and separated by the light absorbing polymeric material (see, e.g., FIGS. 14-18 and 20). In some embodiments, the first column ends of at least one pair 21a, 21b of adjacent polymeric columns include respective first and second non-straight sides 22a, 22b facing one another to define substantially complementary shapes (see, e.g., FIGS. 14-18 and 20). Sides having complementary shapes are shaped to fit together so that the sides can nest with one another when the sides are close to one another. Sides having substantially complementary shapes can be nominally complementary or complementary up to deviations small compared to the length of the side (e.g., deviations less than about 20, 15, or 10 percent of the length), for example.

In some embodiments, a light control film 100 includes a plurality of substantially parallel optically transparent polymeric columns 20 disposed in, and substantially surrounded by, a light absorbing polymeric material 30, such that in at least one cross-section orthogonal to the thickness direction and for each pair of a plurality of adjacent polymeric columns, the adjacent polymeric columns are nested and separated by the light absorbing polymeric material. In some embodiments, for the at least one cross-section and for each pair of the plurality of adjacent polymeric columns, the adjacent polymeric columns have adjacent sides facing each other and concave toward a same direction. In some embodiments, for the at least one cross-section and for each of a plurality of the polymeric columns, the polymeric column has a concave first side 26, a convex second side 29 opposite the concave first side, and opposing substantially straight substantially parallel third and fourth sides 27 and 28 extending between the first and second sides 26 and 29 (see, e.g., FIG. 14).

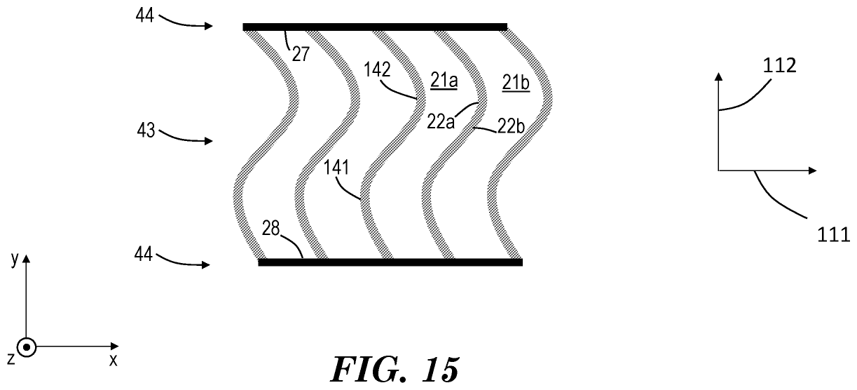

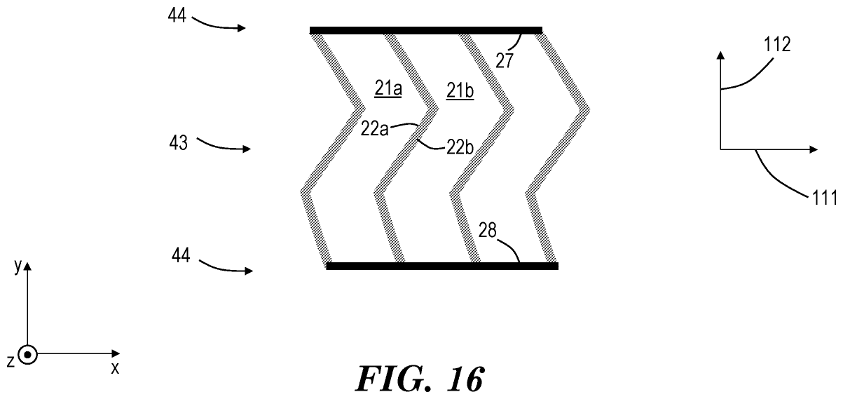

In some embodiments, a light control film 100 includes a plurality of substantially parallel optically transparent polymeric columns 20 disposed in, and substantially surrounded by, a light absorbing polymeric material 30, where each of the polymeric columns has a first column end 21 at the first major surface and an opposite second column end 22 at the second major surface, such that the first column ends of at least one pair 21a, 21b of adjacent first and second polymeric columns include respective first and second non-straight sides 22a, 22b facing one another to define substantially complementary shapes. In some embodiments, the first and second non-straight sides 22a, 22b are concave toward a same direction 111. In some embodiments, the first and second non-straight sides are curved along at least one same direction to define the substantially complementary shapes. In some embodiments, the at least one same direction is a single direction 111 (see, e.g., FIG. 14). In some embodiments, the at least one same direction includes a first direction 111 along a first portion 141 of the first and second sides and a second direction (minus the 111 direction) opposite to the first direction along a second portion 142 of the first and second sides, where the first and second sides are spaced apart along the first direction 111, and the first and second portions spaced are apart along a direction 112 substantially orthogonal to the first direction (see, e.g., FIGS. 15 and 20). In some embodiments, the at least one same direction includes the first direction 111 along a third portion 145 (see, e.g., FIG. 20) of the first and second sides, where the second portion is between the first and third portions. In some embodiments, the first and second non-straight sides 22a, 22b have a zig-zag shape (see, e.g., FIG. 16).

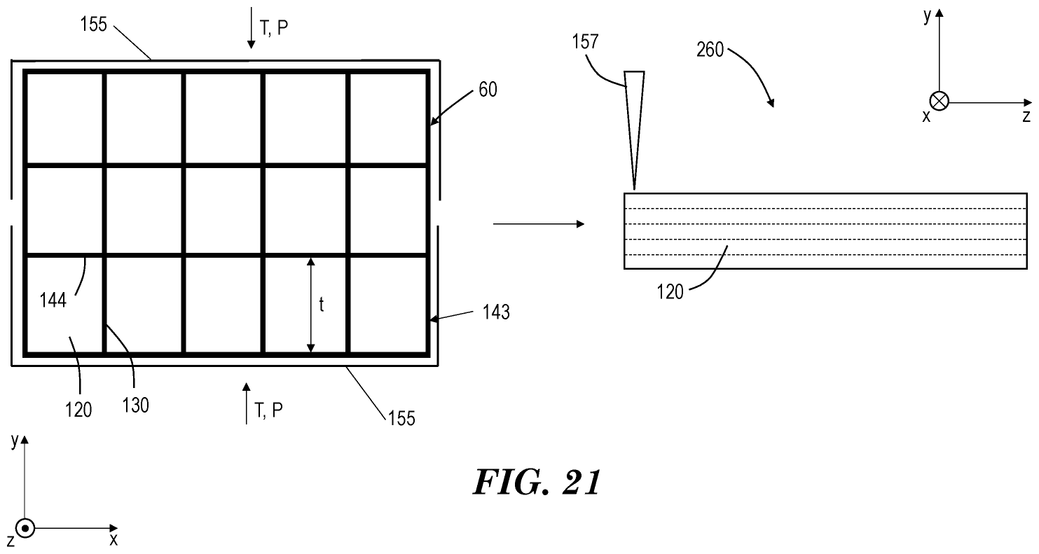

As described further elsewhere herein, in some embodiments, the light control film 100 is formed by cutting (e.g., with blade 157 schematically illustrated in FIG. 21), at least once, a block (e.g., integral block 260 schematically illustrated in FIG. 21) that includes a plurality of substantially parallel optically transparent polymeric columns 20 disposed in, and substantially surrounded by, a light absorbing polymeric material 30, where the cutting results in at least one of the first and second major surfaces 10 and 11. In some embodiments, the cutting includes one or more of skiving, dicing, sawing, and laser cutting. The major surfaces of the cut films can optionally be polished to remove any cutting artifacts. In some embodiments, the cutting includes skiving with a sufficiently sharp blade that polishing is not needed.

FIG. 21 is a schematic illustration of a method of fabricating a light control film 100, according to some embodiments. The method can include providing a plurality of first films 143, where each first film has an orthogonal length (z-direction) and width (x-direction) and includes a plurality of alternating optically transparent polymeric first regions 120 and light absorbing polymeric second regions 130 where the first and second regions extend along the length and are arranged along the width. The first films 143 may be described as louver films and may be made via extrusion. Each first region has a thickness t along a thickness direction (y-direction) substantially orthogonal to the length and width. Here, the thickness direction is a thickness direction of the first films.

In some embodiments, the method can include forming a stack of the first films along the thickness direction (y-direction) applying at least one of pressure and heat to the stack of first films along at least one direction substantially orthogonal to the length, where the at least one of pressure and heat modifies the thickness of the polymeric first regions. For example, an initial thickness t can be reduced to a thickness ta (see, e.g., FIG. 10). In some embodiments, an average thickness of the plurality of polymeric first regions is reduced by at least about 5 or 10% upon applying (and optionally subsequently removing before measuring the resulting reduced average thickness) at least one of pressure and heat to the stack of first films. The average thickness can be reduced up to about a factor of about 2, 1.5, 1.4, 1.3, or 1.2, for example.

In some embodiments, the method can include applying at least one of pressure and heat to the stack 60 of first films 143 along at least one direction substantially orthogonal to the length resulting in an integral block 260 including optically transparent columns 120 formed from the first regions. In some embodiments, the optically transparent columns 120 of the integral block 260 are bonded to one another through light absorbing material of the light absorbing polymeric second regions and the light absorbing layers.

Rows of continuous light absorbing material between rows of optically transparent columns can be formed by including light absorbing layer(s) in the first films 143 and/or by adding light absorbing layers between adjacent first films 143. In some embodiments, each the first films 143 includes at least one light absorbing layer 144 substantially coextensive with the first film along the length and width. In some embodiments, forming the stack 60 of the first films 143 includes disposing a light absorbing layer 144 between each pair of adjacent first films. In some embodiments, applying the at least one of pressure and heat fuses the stacked first films 143 to form a fused stack or integral block 260. In some embodiments, applying the at least one of pressure and heat results in an integral block 260 of optically transparent columns 120 formed from the first regions and bonded to one another through light absorbing material of the light absorbing polymeric second regions and the light absorbing layers. In some embodiments, the method further includes cutting the integral block.

In FIG. 21, the stack 60 of first films 143 are schematically shown in a mold 155 where at least one of pressure (P) and heat (temperature T) can be applied. In some embodiments, applying the heat includes heating the stack 60 of first films 143 at a temperature of at least 80, or 90, or 100, or 110, or 120, or 130 deg. C., depending on the materials used (e.g., 90 deg. C. for PETg or 130 deg. C. for CAB), for at least 2 hours. The temperature is preferably less than each of the thermal decomposition temperatures of the polymeric columns and the light absorbing material. In some embodiments, the heating is for at least 4, or 6, or 8, or 10 hours and may be for up to 48 or 24 hours, for example. In some embodiments, applying the pressure includes applying a pressure of at least 10, or 20, or 30, or 40, or 50 psi to the stack 60 of first films 143 for at least 2 hours. The pressure may be up to 500 psi or up to 200 psi, for example. In some embodiments, the pressure is applied for at least 4, or 6, or 8, or 10 hours and may be applied for up to 48 or 24 hours, for example. A hot press or an autoclave, for example, may be used to apply the heat and/or pressure.

In some embodiments, applying the at least one of pressure and heat results in the light absorbing polymeric material 144 bonding the first films 143 to one another to form an integral block 260 of the optically transparent polymeric first regions 120 substantially surrounded by light absorbing material 144, 130. In some embodiments, the method further includes cutting (e.g., using blade 157) the integral block 260. For example, the light control film 100 may be cut from the integral block 260. The cutting can be carried out after the integral block has been removed from the mold 155 and allowed to cool down. The cutting may include one or more of skiving, dicing, sawing, and laser cutting, for example.

### EXAMPLES

These examples are merely for illustrative purposes only and are not meant to be limiting on the scope of the appended claims. All parts, percentages, ratios, etc. in the examples and the rest of the specification are by weight, unless noted otherwise.

### Materials

| Abbreviation | Description |
|---|---|
| Plasticizer | Bis(2-ethylhexyl) Adipate or (CH₂CH₂CO₂C₈H₁₇)₂ |
| CAB (clear) | Cellulose acetate butyrate available from Eastman |
| | Chemical Company (Kingsport, TN) under the |
| | tradename TENITE and mixed with 10 percent |
| | Plasticizer. |
| CAB (black) | Cellulose acetate butyrate available from Eastman |
| | Chemical Company (Kingsport, TN) under the |
| | tradename TENITE mixed with 1.02% carbon black |
| | by weight and 4% Plasticizer by weight. |
| GN071 PETg | Glycol modified polyethylene terephthalate available |
| (clear) | from Eastman Chemical Company (Kingsport, TN) under |
| | the tradename EASTAR GN071. |
| GN071 PETg | GN071 PETg (clear) mixed with approximately 0.22% |
| (black) | carbon black by weight. |
| 14285 PETg | Glycol modified polyethylene terephthalate available |
| (clear) | from Eastman Chemical Company (Kingsport, TN) under |
| | the tradename EASTMAN COPOLYESTER 14285. |

Films were extruded through a die at the rates and temperatures shown in the table below.

| | 18 mm Twin | 27 mm Twin | 27 mm Twin | Cast | Cast |
|---|---|---|---|---|---|
| Example | Screw | Screw (Thin | Screw (Thick | Film | Film |
| Number | (Skin) | Louvers) | Louvers) | Thickness | Width |
| 1 | CAB (black) | CAB (black) | CAB (clear) | 251 | 3.1 cm |
| | @ 218 C. | @ 218 C. | @ 227 C. | micron | (1.22″) |
| | 0.95 Kg/hr | 0.86 Kg/hr | 3.45 Kg/hr | (0.0099″) | |
| 2 | CAB (black) | CAB (black) | CAB (clear) | 218 | 2.64 cm |
| | @ 213 C. | @ 213 C. | @ 213 C. | micron | (1.04″) |
| | 0.91 Kg/hr | 0.91 Kg/hr | 4.54 Kg/hr | (0.0086″) | |
| 3 | GN071 PETg | GN071 PETg | 14285 PETg | 251 | 2.82 cm |
| | (black) | (black) | (clear) | micron | (1.11″) |
| | @ 271 C. | @ 271 C. | @ 260 C. | (0.0099″) | |
| | 0.91 Kg/hr | 0.86 Kg/hr | 7.76 Kg/hr | | |

### Example 1

A film composed of cellulose acetate butyrate was extruded at the rates and temperatures shown in the table above. The film sample included 120 louver pairs, where a pair consisted of one transparent louver and one black pigmented louver. The film also had a thin black pigmented skin on both top and bottom surfaces. The louver melt stack was compressed within the die from 25 cm (10″) wide to 4.8 cm (1.88″) at the die exit. The extrudate was further drawn down between the die exit and the casting wheel, resulting in a narrower and thinner cast web. The table above details the cast film thickness and width. The film was slit down to approximately 2.4 cm (0.93″) wide and then cut and stacked in a 2.54 cm (1″) wide sample holder. The filled holder was put in an autoclave pressurized oven manufactured by ASC corporation. A vacuum of approximately 28″ Hg was pulled on the bagged sample while the oven was heated to 130 C (266° F.) and 517 kPa (75 psi). The heat up cycle was approximately 2.5 hours followed by a 4-hours heat soak. The vacuum and pressure were maintained during the heat soak cycle. After approximately 6.5 hours, the oven was cooled to 38° C. (100° F.) and the pressure and vacuum released. After the autoclave cycle, the top cap of the sample holder had compressed all the way down to the walls of the sample holder body and excess material had squeezed out each end. When the block was removed from the sample holder, it appeared well fused. The fused block was then skived into thin sections using a lab scale skiving machine to produce light control films. FIGS. 17-19 are top view images of this film with different cutting parameters. FIG. 7 shows a plot of transmittance from a 530 nanometer light source versus angle for the resulting light control films skived to 230 and 550 micron thicknesses. The samples were polished prior to the transmittance being measured.

### Example 2

A film composed of cellulose acetate butyrate extruded at the rates and temperatures shown in the table above. This film sample included 120 louver pairs, where a pair consisted of one transparent louver and one black pigmented louver. The film also had a thin black pigmented skin on both top and bottom surfaces. The louver melt stack was compressed within the die from 25 cm (10″) wide to 4.8 cm (1.88″) at the die exit. The extrudate was subsequently run through a layer multiplier, which tripled the number of louvers to 360 louver pairs. The extrudate was drawn down between the multiplier exit and the casting wheel, resulting in a narrower and thinner cast web. The table above details the cast film thickness and width.

Approximately 250 20 cm long strips of this film were cut and stacked. The stack of strips was placed in a spring-loaded fixture with the moving plate of the fixture retracted and held in in the retracted position using nuts on threaded rods. The nuts on the threaded rods were then removed, allowing the springs to push the moving plate to compress the stack of film strips against a fixed plate of the fixture. The loaded fixture was placed in a preheated oven at 130° C. (266° F.) for 5.5 hours. When the loaded fixture was placed in the oven, the springs were applying approximately 234 lbs. of force to the plate. At the completion of the fusing process, the springs were applying approximately 72 lbs. as the strips compressed and the springs expanded.

The fused block was skived into 210 micron thick sections using a lab scale skiving machine to produce light control films. FIG. 7 shows a plot of transmittance versus angle for the resulting light control film scanned in the cross web (CW) and down web (DW) directions. The samples were polished prior to the transmittance being measured.

### Example 3

A film composed of two grades of glycol-modified polyethylene terephthalate (PETg) extruded at the rates and temperatures shown in the table above. The same hardware as Example 2 was used, resulting in 360 louver pairs. The table above details the cast film thickness and width.

Approximately 220 20 cm long strips of the film were cut and stacked. The strips were placed in the spring-loaded fixture described in Example 2 with the moving plate pulled back. For this sample, the loaded fixture was heated at 90° C. for 2 hours with minimal spring pressure to soften the film, then full spring pressure was applied for an additional 2 hours. The spring forces were approximately the same as for Example 2.

The resulting fused block was skived into 450 micron thick sections using a lab scale skiving machine to produce light control films. FIG. 20 is a top view image of a resulting light control film. FIG. 7 shows a plot of transmittance versus angle for the light control film scanned in the cross web (CW) and down web (DW) directions. The samples were polished prior to the transmittance being measured. In some of the samples, the black louvers were curved so that opposing surfaces of the black louvers were nested.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. A light control film comprising:
opposing substantially planar substantially parallel first and second major surfaces spaced apart along a thickness direction of the light control film by less than about 500 microns; and
a plurality of substantially parallel optically transparent polymeric columns disposed in, and substantially surrounded by, a light absorbing polymeric material, each of the polymeric columns having a first column end at the first major surface and an opposite second column end at the second major surface, each of the polymeric columns having an aspect ratio of greater than about 3, such that the first column ends are arranged to define a plurality of substantially parallel alternating substantially linear rows of the first column ends and substantially linear rows of continuous light absorbing polymeric material, wherein for each pair of a plurality of adjacent first column ends, the adjacent first column ends are nested and separated by the light absorbing polymeric material.

17. The light control film of claim 16, wherein the rows of continuous light absorbing polymeric material are thinner than the rows of first column ends.

18. The light control film of claim 16, wherein the first column ends of each row of first column ends are separated by light absorbing polymeric material.

19. The light control film of claim 16, wherein for each pair of the plurality of adjacent polymeric columns, the adjacent polymeric columns have adjacent sides facing each other and concave toward a same direction.

20. The light control film of claim 16, wherein the polymeric columns have an in-plane aspect ratio of less than 5.

21. The light control film of claim 16, wherein the plurality of first column ends is more periodic along a first direction and less periodic along a second direction substantially orthogonal to the first direction.

22. The light control film of claim 16, wherein the first column ends define a plurality of substantially parallelogram shapes arranged into a plurality of substantially parallel substantially linear rows, wherein at least some of the substantially parallelogram shapes have no right angles.

23. The light control film of claim 22, wherein at least 50 percent of the substantially parallelogram shapes have no right angles.

24. The light control film of claim 22, wherein at least 70 percent of the substantially parallelogram shapes have no right angles.

25. The light control film of claim 16, wherein for a substantially collimated incident light having a wavelength in a wavelength range from about 400 nm to about 2000 nm, an optical transmittance of the light control film versus an incident angle of the incident light in a first incident plane has a peak transmittance of greater than about 2% with a corresponding first full width at half maximum (FWHM) of between about 5 degrees and about 120 degrees.

26. The light control film of claim 25, wherein an optical transmittance of the light control film versus an incident angle of the incident light in a second incident plane different from the first incident plane has a transmitted peak with a corresponding second FWHM different from the first FWHM by at least about 10%.

27. A light control film comprising:
opposing substantially planar substantially parallel first and second major surfaces spaced apart along a thickness direction of the light control film by less than about 750 microns; and
a plurality of substantially parallel optically transparent polymeric columns disposed in, and substantially surrounded by, a light absorbing polymeric material, each of the polymeric columns having a first column end at the first major surface and an opposite second column end at the second major surface, each of the polymeric columns having an aspect ratio of greater than about 3, such that the first column ends of at least one pair of adjacent first and second polymeric columns comprise respective first and second non-straight sides facing one another to define substantially complementary shapes, wherein the polymeric columns are arranged to define a plurality of substantially parallel alternating substantially planar rows of the columns and substantially planar rows of continuous light absorbing polymeric material.

28. The light control film of claim 27, wherein for each pair of a plurality of adjacent polymeric columns, the adjacent polymeric columns are nested and separated by the light absorbing polymeric material.

29. The light control film of claim 27, wherein for a substantially collimated incident light having a wavelength in a wavelength range from about 400 nm to about 2000 nm, an optical transmittance of the light control film versus an incident angle of the incident light in a first incident plane has a peak transmittance of greater than about 2% with a corresponding first full width at half maximum (FWHM) of between about 5 degrees and about 120 degrees.

30. A method of fabricating a light control film, comprising:
providing a plurality of first films, each first film having an orthogonal length and width and comprising a plurality of alternating optically transparent polymeric first regions and light absorbing polymeric second regions, the first and second regions extending along the length and arranged along the width, each first region having a thickness along a thickness direction substantially orthogonal to the length and width;
forming a stack of the first films along the thickness direction; and
applying at least one of pressure and heat to the stack of first films along at least one direction substantially orthogonal to the length resulting in an integral block comprising optically transparent columns formed from the first regions, wherein the columns are arranged to define a plurality of substantially parallel alternating substantially planar rows of the columns and substantially planar rows of continuous light absorbing polymeric material, wherein the at least one of pressure and heat modifies the thickness of the polymeric first regions, such that in at least one cross-section orthogonal to the thickness direction and for each pair of a plurality of adjacent columns, the adjacent columns are nested and separated by the light absorbing polymeric material.

31. The method of claim 30, wherein each the first films comprises at least one light absorbing layer substantially coextensive with the first film along the length and width.
